(19) United States
(12) Patent Application Publication
(10) Pub. No.: US 2026/0289046 A1
(43) Pub. Date: Sep. 24, 2026

(54) HYBRIDIZATION OF PHYSICS-BASED SIMULATOR WITH MACHINE LEARNING MODEL

(71) Applicant: Schlumberger Technology Corporation, Sugar Land, TX (US)

(72) Inventor: Konstantin Fedorovich Sinkov, Lysaker (NO)

(21) Appl. No.: 19/086,223

(22) Filed: Mar. 21, 2025

(51) Int. Cl. G06F 30/27; G06F 30/28

(52) U.S. Cl. CPC G06F 30/27; G06F 30/28

(57) ABSTRACT

A method for hybridizing a physics-based simulator with a machine learning (ML) model includes receiving input data. The method may also include simulating variables based upon the input data. The method may also include predicting closures based upon the input data and the variables. The method may also include simulating outputs based upon the closures. The method may also include determining a loss function based upon the closures and/or the outputs. The method may also include determining gradients of the loss function. The method may also include updating a machine-learning (ML) model based upon the gradients to produce an updated ML model. The method may also include generating a hybrid output using the updated ML model.

### BACKGROUND

Conventional models based on first principles (e.g., mass and momentum conservation) often involve empirical or semiempirical constitutive closure relations. These relations may be established and calibrated by comparing model predictions against experimental data. Establishing and calibrating the closure relations can be a labor-intensive and time-consuming process. Automation of the closure relations calibrating with a ML model can help to streamline this process.

Conventional hybridization involves a back-calculation of a variable of interest (e.g., in the case of simulating multiphase pipe flow, gas-liquid interfacial friction factor) from data. The back-calculation for other closure relations may be cumbersome, if possible, and can amplify uncertainties in the data. In addition, it can be done under the condition that the rest of the closure relations are fixed. This approach is not feasible for incomplete data (e.g., in the case of simulating multiphase pipe flow, containing a pressure drop, but not a liquid holdup). Therefore, what is needed is a new system and method that does not involve solving an inverse problem and/or allows training of a machine learning (ML) model for multiple closures simultaneously.

### SUMMARY

A method for hybridizing a physics-based simulator with a machine learning (ML) model is disclosed. The method includes receiving input data. The method also includes simulating variables based upon the input data. The method also includes predicting closures based upon the input data and the variables. The method also includes simulating outputs based upon the closures. The method also includes updating a machine-learning (ML) model based upon the outputs to produce an updated ML model.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving input data. The operations also include simulating variables based upon the input data. The operations also include transforming the input data to produce transformed input data. The operations also include transforming the variables to produce transformed variables. The operations also include predicting closures based upon the transformed input data and the transformed variables. The closures are predicted using a machine learning (ML) model. The operations also include simulating outputs based upon the closures. The outputs are simulated using a simulator. The operations also include determining a loss function based upon the closures and/or the outputs. The operations also include determining gradients of the loss function. The operations also include updating the ML model based upon the gradients to produce an updated ML model. The operations also include generating a hybrid output using the updated model.

A non-transitory computer-readable medium is also disclosed. The medium stores instructions that, when executed by one or more processors of a computing system, cause the computing system to perform operations. The operations include receiving input data. The input data includes superficial velocities of fluids, densities of the fluids, viscosities of the fluids, surface tensions for pairs of the fluids, a diameter of a pipe through which the fluids flow, an inclination of the pipe with respect to horizontal, a roughness of an interior of the pipe, or a combination thereof, and wherein the fluids comprise gas, oil, water, or a combination thereof. The operations also include simulating variables based upon the input data. The operations also include transforming the input data to produce transformed input data. The operations also include transforming the variables to produce transformed variables. The operations also include predicting closures based upon the transformed input data and the transformed variables. The closures are predicted using a machine learning (ML) model. The operations also include simulating outputs based upon the closures. The outputs are simulated using a simulator. The operations also include determining a loss function based upon the closures and/or the outputs. The operations also include determining gradients of the loss function. The operations also include updating the ML model based upon the gradients to produce an updated ML model. The operations also include generating a hybrid output using the updated model. The hybrid output includes (1) the outputs simulated based on input data and the closures, (2) the closures predicted based on the transformed input data and transformed variables, or both.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an architecture of a hybrid model, according to an embodiment.

FIG. 3 illustrates a schematic view of a plurality of modules for incorporating the simulator into a machine learning (ML) model, according to an embodiment.

FIGS. 4A-4F illustrate graphs showing a comparison of the hybrid model performance against a pure physics-based model, according to an embodiment.

FIGS. 5A-5F illustrate graphs showing a comparison of hybrid model performance against the pure physics-based model, according to an embodiment.

FIG. 6 illustrates a flowchart of a method for hybridizing a physics-based simulator with a ML model, according to an embodiment.

FIG. 7 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

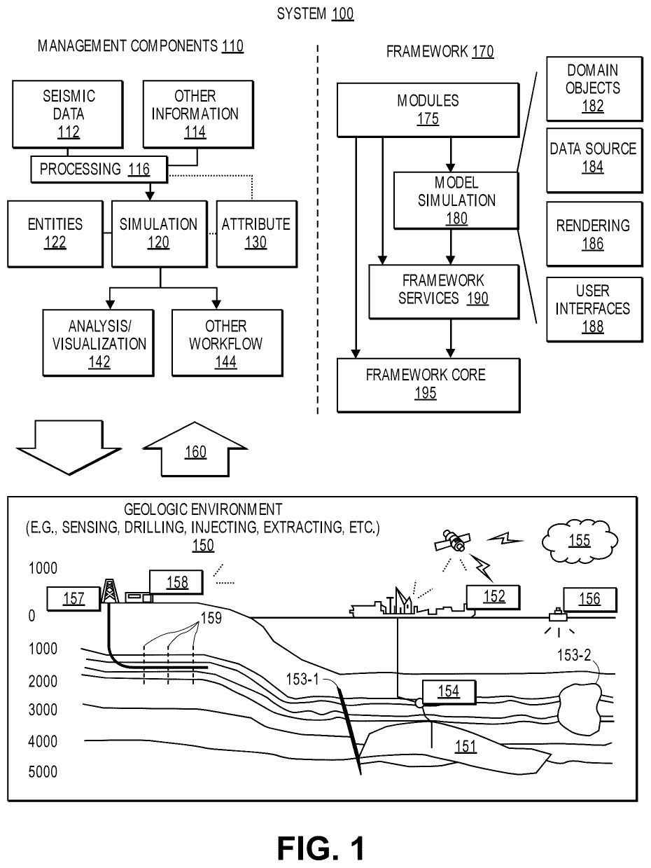

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116 (e.g., including calibration of the processing results with well data), a simulation component 120, an attribute component 130, an analysis/visualization component 142 and a workflow component 144. In operation, seismic data and other information provided per the components 112 and 114 may be input to the simulation component 120. The other information may be or include well data. The components, 112, 114 may be or include well data such as well logs, drilling logs, and/or cores, which may be used to calibrate the seismic data to rock and fluid properties.

In an example embodiment, the simulation component 120 may rely on entities 122. Entities 122 may include earth entities or geological objects such as wells, well data (e.g., used for calibration of rock and fluid properties), surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workstep may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

Hybridization of Physics-Based Simulator with Machine Learning Model

The present disclosure provides a method that automates physics-based model tuning with the help of machine learning (ML) techniques. The method may also solve the opposite problem of incorporating physical constraints to data-driven models for multiphase flows. In some embodiments, the method may co-tune sub-models of the physics-based model to simultaneously minimize error with respect to experimental data for microparameters and multiple model outputs.

The method described herein connects the ML model to a physics-based simulator such that the ML model effectively acts as a closure relation. The predictions from the hybrid model are then compared to data, and the ML model parameters may be trained to produce a better match though error backpropagation.

In the case of a dynamic multiphase flow simulator (e.g., OLGA®), the experimental data may include steady-state laboratory measurements. An API enables programmatic tuning of some of the closures without altering other ones and the entire solution framework. The examples below connect neural net to the tuning API.

In contrast to conventional methods for hybridization either using a first principles simulator for augmentation of features for the ML model or outputs of the ML model as closure relations for simulator, the method described herein establishes a two-way connection between the ML model and the first-principle simulator, such that internal variables of the simulator are used as features for the ML model. In addition, the method combines multiple outputs from the physical simulator in a loss function to solve multi-regression or mixed regression-classification tasks.

Physical constraints can be imposed on the ML models by enriching the training dataset, which includes experimental data with the artificial data generated by the physics-based model. The surrogate model being trained this way inherits some knowledge from the physical model indirectly. The method explicitly imposes constraints described by the physical simulator while training ML model.

The method implements hybrid physics and trains a ML-based model to fit data while simultaneously satisfying physical constraints. The hybrid model architecture replaces some of the constitutive closure relations previously used by a physical simulator with the ML model.

In an example (e.g., using the dynamic multiphase flow simulator), an automated tuning procedure can make feasible the creation of custom versions of the model favoring specific datasets or tailored to certain ranges of parameters, which may become a separate service. Another possible application is a problem-specific model calibration for anomaly detection in online workflows.

Data-based proxies generated by the dynamic multiphase flow simulator may replace the simulator with surrogate models. A hybrid approach can help to combine strengths of two approaches.

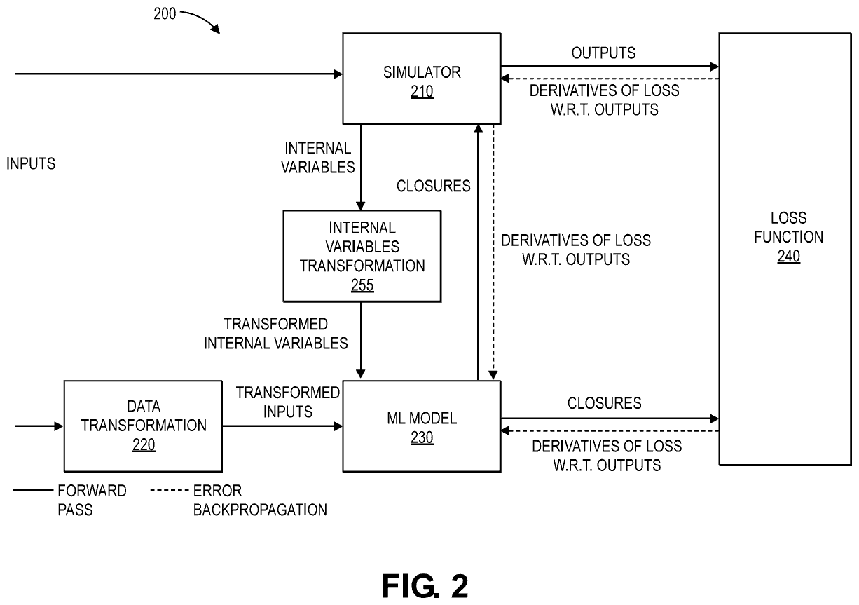

FIG. 2 illustrates an architecture of a hybrid model 200, according to an embodiment. Inputs may be provided to both the first principle-based simulator 210 and, after (e.g., optional) data transformation 220 and/or internal variable transformation 225 to an ML model 230. Additionally, some of internal variables from the simulator 210 (e.g., intermediate simulation results which are not measurable or available as outputs) are also supplied as features for the ML model 230. Predictions from the ML model 230 may be interpreted as values of closures (i.e., constitutive relations) used by the simulator 210. Outputs of the simulator may be determined based upon the closures and compared against experimental data to calculate quantitative measures of mismatch by a loss function 240. If experimental data for variables described by the closures is also available, corresponding terms can be incorporated to the loss function 240. To back propagate error and optimize parameters of the ML model 230, derivatives of the loss function 240 with respect to the outputs, closures, and derivatives of the outputs with respect to the closures may also be determined. If the simulator 210 can't provide the latter derivatives, they can be calculated using perturbing values of the closures and approximating by finite difference formulas. Then, total gradients of the loss function 240 with respect to the ML model parameters (e.g., weights) may be determined using the formula:

$$\frac{\partial Loss function}{\partial Weights} = ( \frac{\partial Loss function}{\partial Outputs} \cdot \frac{\partial Outputs}{\partial Closures} + \frac{\partial Loss function}{\partial Closures} ) \cdot \frac{\partial Closures}{\partial Weights} \qquad ( 1 )$$

The total gradients may then be used to adjust parameters of the ML model 230 by one or more optimization algorithms. The loss function 240 can be based on one or multiple outputs from the simulator 210. Adjusting weights of terms corresponding to different outputs can balance the accuracy of the model for different outputs. The models may also be trained by matching experimental data for parameters provided by the closures and not being part of the standard outputs of the simulator 210, if it is available.

The method is different from conventional (possibly multidimensional) optimization of simulator parameters. It discovers a functional form of the constitutive closure relationships having the inputs and internal variables as arguments instead of optimizing values of unknown coefficients given a predefined functional form of the closures.

In the examples below, the simulator 210 may be or include a dynamic multiphase flow simulator (e.g., OLGA-S®)—a steady-state (e.g., point) version of the OLGA® model, and the ML model 230 may be or include a neural net (NN). The inputs may be physical quantities that are provided as input to the simulator 210 such as superficial velocities of fluids (e.g., gas, oil and water), densities and viscosities of fluids, surface tensions for fluid pairs (e.g., gas-oil, gas-water and oil-water), pipe diameter, inclination with respect to horizontal, roughness, or a combination thereof. The transformed inputs may be dimensionless Froude and Reynolds numbers for gas and effective liquid with properties averaged between oil and gas, Weber numbers for a gas-effective liquid pair, a density ratio of gas and liquid, a pipe inclination, relative roughness, or a combination thereof. The data transformation may be module computing dimensionless similarity criteria from the inputs. The closures may be simulator model turbulence parameters (scaled turbulent viscosities at the gas-liquid and oil-water interfaces). The outputs may be outputs of the simulator 210 such as pressure drop, liquid holdup, water holdup, flow regime ID, or a combination thereof. The particular examples don't use internal variables from the simulator 210; however, they may include in-situ fluids velocities, layers densities etc. The loss function 240 may be a weighted sum of model prediction errors for pressure drop, liquid holdup, and/or water holdup relative to experimental data.

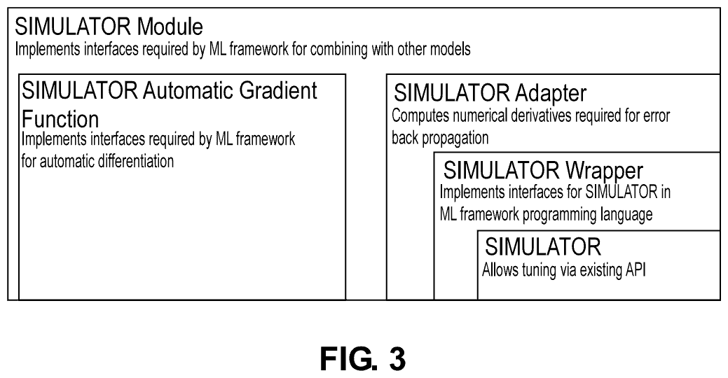

FIG. 3 illustrates a schematic view of a plurality of modules for incorporating the simulator (e.g., OLGA-S®) 210 into a PyTorch ML model, according to an embodiment. The NN and the hybrid model may be implemented and trained using a PyTorch framework. The simulator 210 may be introduced to the PyTorch model as a custom computational graph node using the framework extensibility features. The same approach can be used with any other ML framework allowing customization of computational graph with user defined functions.

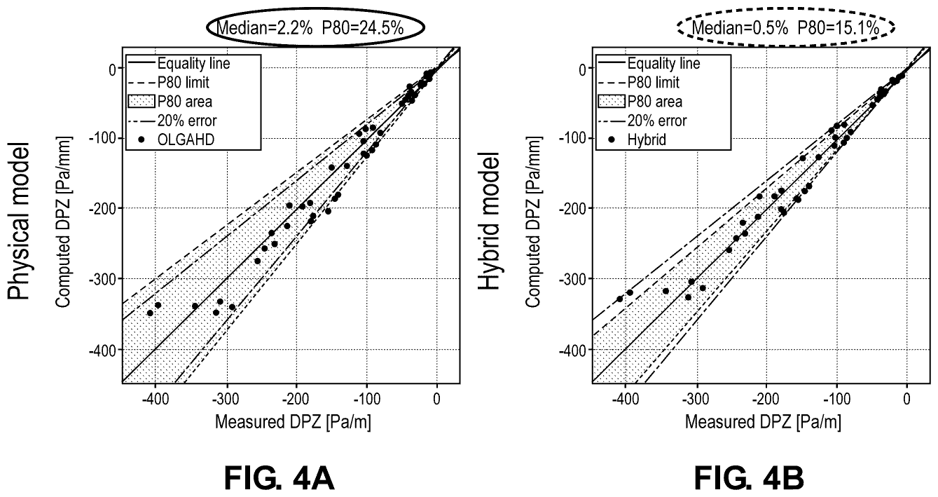

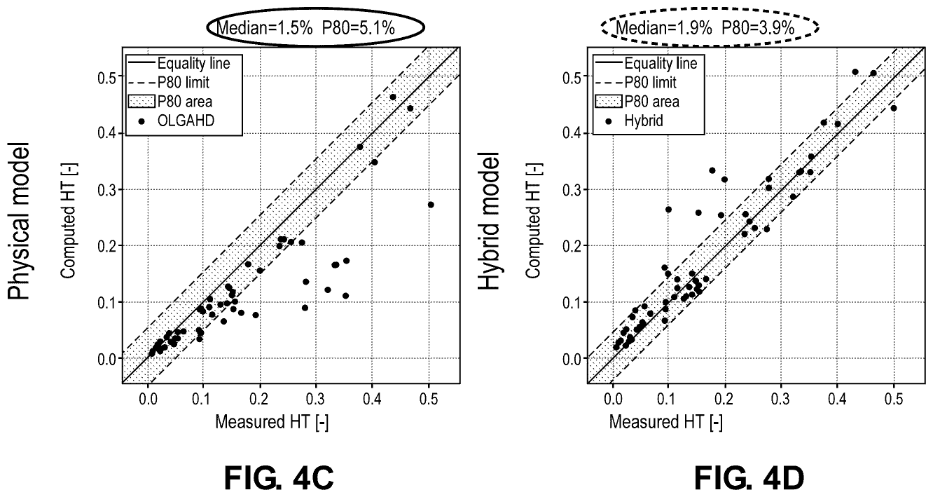

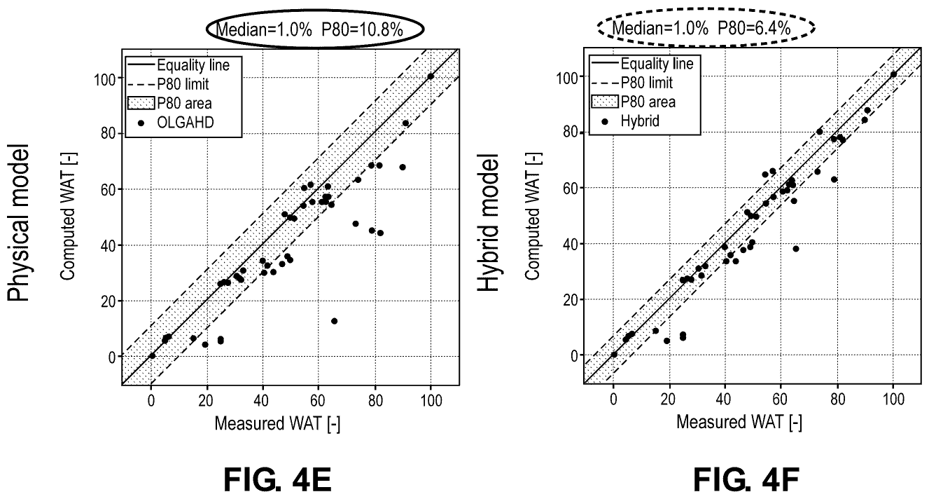

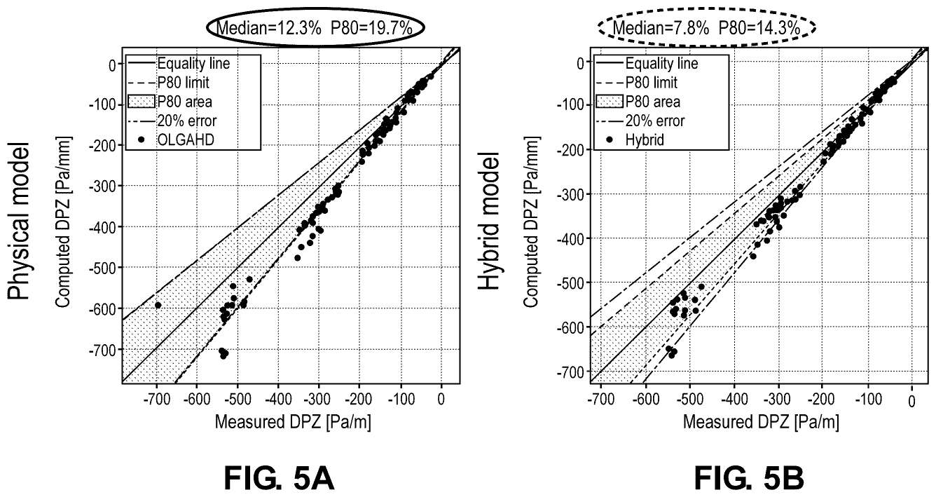

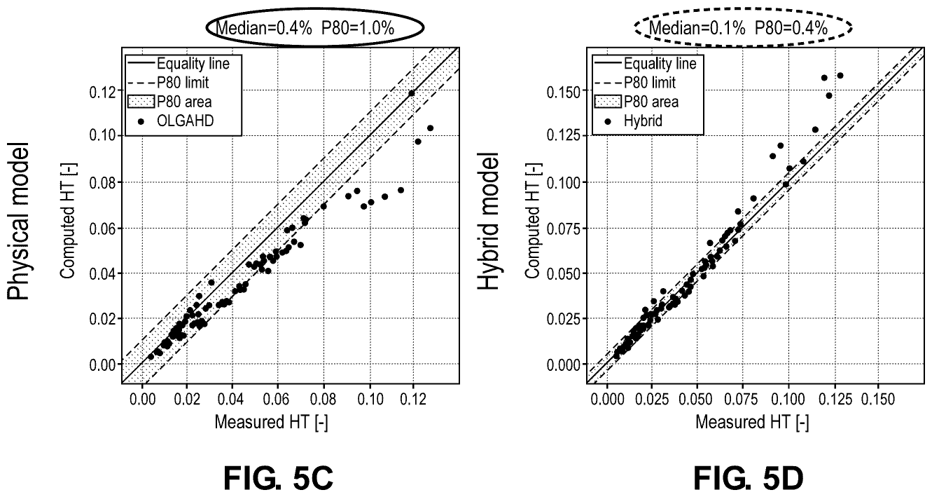

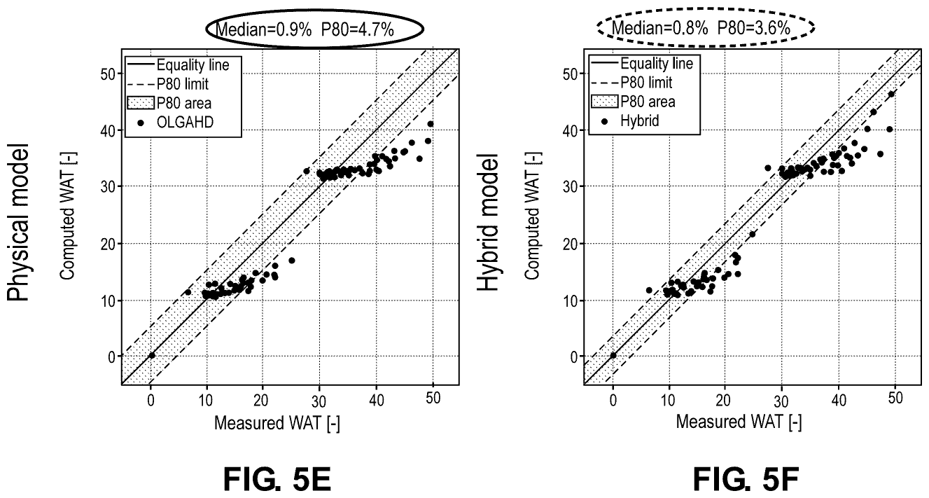

FIGS. 4A-4F and 5A-5F illustrate graphs showing examples of hybrid model performance compared to a reference model (e.g., a pure physics-based OLGA® HD model). More particularly, FIGS. 4A-4F illustrate graphs showing a comparison of the hybrid model performance against a pure physics-based OLGA® HD model, according to an embodiment. In this example, a pressure drop (DPZ), a total liquid holdup (HT), and a water holdup (WAT) are the target variables, and a gas turbulence parameter is the closure being tuned. More particularly, the graphs in FIGS. 4A-4F show a comparison of the hybrid model trained to predict DPZ, HT, and WAT using single tuning. The hybrid model results are better for the median error and P80 statistics for DPZ and WAT. Although median error for HT is slightly higher, the hybrid model shows less scattering of point resulting in improvement of P80 statistics compared to the reference model.

FIGS. 5A-5F illustrate graphs showing a comparison of hybrid model performance against the pure physics-based OLGA® HD model, according to an embodiment. In this example, the target variables are pressure drop, liquid holdup, and water holdup. The gas and water turbulence parameters are the closures being tuned. More particularly, FIGS. 5A-5F show results of the hybrid model trained to predict DPZ, HT, and WAT simultaneously, and tuning gas and water turbulence parameters closures. The experimental dataset is different from the previous example. Metrics for the target variables are improved uniformly. The hybrid model predictions for WAT are also qualitatively different from ones by reference physics-based model. Horizontal “ridges” in the physics-based model predictions, where computed values don't vary contrary to the variation of the measured values, indicate a lack of sensitivity of the model to certain inputs. The hybrid model at least partially introduces lacking sensitivity and eliminates unphysically looking groups of points in parity plot.

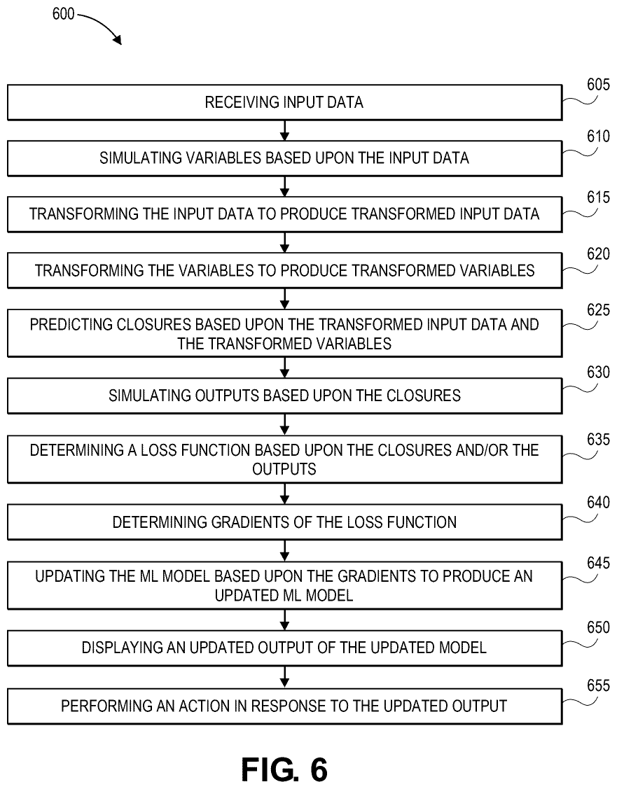

FIG. 6 illustrates a flowchart of a method 600 for hybridizing a physics-based simulator with a machine learning (ML) model, according to an embodiment. An illustrative order of the method 600 is provided below; however, one or more portions of the method 600 may be performed in a different order, simultaneously, repeated, or omitted. At least a portion of the method 600 may be performed with a computing system (described below). FIG. 2 (described above) illustrates a schematic view of the method 600 in FIG. 6.

The method 600 may include receiving input data, as at 605. The input data may include superficial velocities of fluids, densities of the fluids, viscosities of the fluids, surface tensions for pairs of the fluids, a diameter of a pipe through which the fluids flow, an inclination of the pipe with respect to horizontal, a roughness of an interior of the pipe, or a combination thereof. The fluids may be or include gas, oil, water, or a combination thereof. The pairs of the fluids may include gas-oil, gas-water, oil-water, or a combination thereof.

The method 600 may also include simulating variables based upon the input data, as at 610. The variables may be simulated using the simulator 210 (see FIG. 2). The variables may include internal variables (e.g., that are measurable or not). The internal variables may include in-situ velocities of the fluids, in-situ velocities of layers of the fluids, densities of layers of the fluids, effective viscosities of the layers of the fluids, or a combination thereof.

The method 600 may also include transforming the input data to produce transformed input data, as at 615. The input data may be transformed using the data transformation module 220 (see FIG. 2). The transformed input data may be or include dimensionless Froude and/or Reynolds numbers that are based upon the superficial velocities of the fluids for the gas and an effective liquid with properties averaged between the oil and the water, a Weber number for a gas-effective liquid pair that is based upon a the superficial velocity of the gas, a density ratio of the gas and the liquid, the inclination of the pipe, the roughness of the interior of the pipe, or a combination thereof.

The method 600 may also include transforming the variables to produce transformed variables, as at 620. Transforming the variables may include transforming the internal variables. The (e.g., internal) variables may be transformed using the variables transformation module 225 (see FIG. 2). The transformed variables may be or include dimensionless Froude and/or Reynolds numbers that are based on the in-situ velocities of the fluids, the in-site velocities of the layers of the fluids, the densities of the layers of the fluids, the effective viscosities of the layers of the fluids, or a combination thereof.

The method 600 may also include predicting closures based upon the transformed input data and the transformed variables, as at 625. The closures may be predicted using the machine learning (ML) model 230 (see FIG. 2). The closures may be or include turbulence parameters. The ML model may be or include a neural net.

The method 600 may also include simulating outputs based upon the closures, as at 630. The outputs may be simulated using the simulator 210 (see FIG. 2). The outputs may be or include a pressure drop, a liquid holdup, a water holdup, an indicator of a flow regime, or a combination thereof.

The method 600 may also include determining a loss function based upon the closures and/or the outputs, as at 635. The loss function may be or include a quantitative measure of mismatch between the outputs and/or the closures compared versus experimental data. The loss function may be or include a weighted sum of errors for the pressure drop, the liquid holdup, the water holdup, and/or the flow regime relative to the experimental data.

The method 600 may also include determining gradients of the loss function, as at 640. The gradients may be determined based upon derivatives of the loss function with respect to the outputs, derivatives of the outputs with respect to the closures, derivatives of the loss function with respect to the closures, derivatives of the closures with respect to parameters of the ML model, or a combination thereof. The derivatives of the outputs may be simulated using the simulator 210 (see FIG. 2) or by perturbing values of the closures and then approximating the perturbed values with finite difference formulas.

The method 600 may also include updating the ML model 230 (see FIG. 2) based upon the outputs, the loss function, and/or the gradients to produce an updated ML model, as at 645. The ML model 230 may be updated by modifying the parameters of the ML model. The parameters may be or include matrices of weights and vectors of biases.

The method 600 may also include displaying a hybrid output of the updated model (also referred to as a hybrid model), as at 650. The hybrid output may be or include (1) the outputs simulated based on input data and the closures and/or (2) the closures predicted based on the transformed input data and transformed variables.

The method 600 may also include performing an action in response to the hybrid output, as at 655. The action may be or include generating and/or transmitting a signal that recommends, instructs, or causes a physical action to occur. The physical action may be or include optimizing a performance (and/or troubleshooting) of a multiphase pipeline transportation and/or well production system by actuating valves in the pipe and/or chokes at a wellhead that is connected to the pipe. The physical action may also or instead include varying a flow rate through the pipe or a well that is connected to the pipe by adjusting frequencies of pumps or compressors or actuating downhole control devices, injecting chemicals to prevent formation of hydrates, scales, and/or corrosion, or combination of thereof.

### Exemplary Computing System

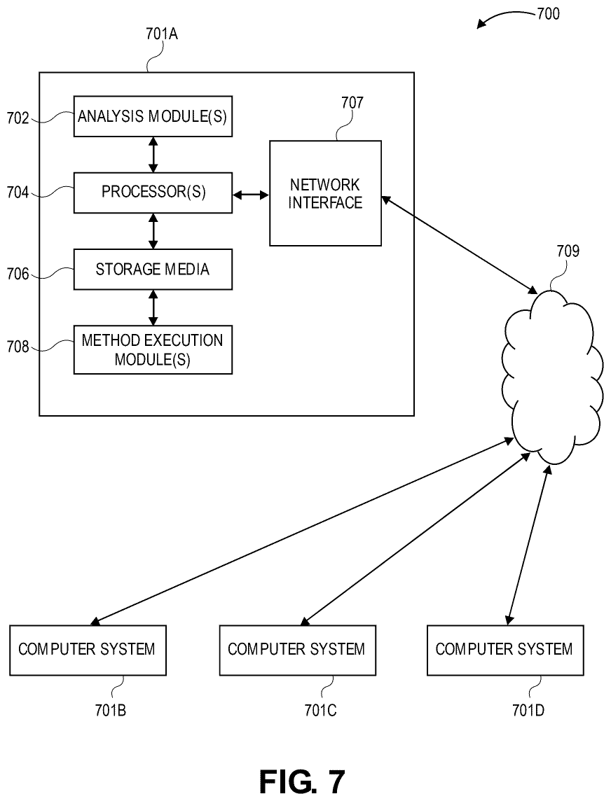

In some embodiments, the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 700 contains one or more de-risking module(s) 708. In the example of computing system 700, computer system 701A includes the de-risking module 708. In some embodiments, a single de-risking module may be used to perform some aspects of one or more embodiments of the methods disclosed herein. In other embodiments, a plurality of de-risking modules may be used to perform some aspects of methods herein.

It should be appreciated that computing system 700 is merely one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for hybridizing a physics-based simulator with a machine learning (ML) model, the method comprising:
receiving input data;
simulating variables based upon the input data;
predicting closures based upon the input data and the variables;
simulating outputs based upon the closures; and
updating a machine-learning (ML) model based upon the outputs to produce an updated ML model.

2. The method of claim 1, wherein the physics-based simulator comprises a steady-state multiphase pipe flow simulator, and wherein the ML model comprises a neural net.

3. The method of claim 2, wherein the ML model is updated by modifying matrices of weights and vectors of biases of the neural net.

4. The method of claim 2, wherein the input data comprises superficial velocities of fluids, densities of the fluids, viscosities of the fluids, surface tensions for pairs of the fluids, a diameter of a pipe through which the fluids flow, an inclination of the pipe with respect to horizontal, a roughness of an interior of the pipe, or a combination thereof, and wherein the fluids comprise gas, oil, water, or a combination thereof.

5. The method of claim 1, further comprising:
transforming the input data to produce transformed input data; and
transforming the variables to produce transformed variables, wherein the closures are predicted based upon the transformed input data and the transformed variables.

6. The method of claim 1, further comprising determining a loss function based upon the closures and/or the outputs, wherein the loss function comprises a quantitative measure of mismatch between the outputs and/or the closures compared versus experimental data.

7. The method of claim 6, further comprising determining gradients of the loss function, wherein the gradients are determined based upon derivatives of the loss function with respect to the outputs, derivatives of the outputs with respect to the closures, derivatives of the loss function with respect to the closures, derivatives of the closures with respect to parameters of the ML model, or a combination thereof.

8. The method of claim 1, further comprising:
generating a hybrid output using the updated ML model; and
displaying the hybrid output.

9. The method of claim 1, further comprising performing an action in response to the hybrid output.

10. A computing system, comprising:
one or more processors; and
a memory system comprising one or more non-transitory computer-readable media storing instructions that, when executed by at least one of the one or more processors, cause the computing system to perform operations, the operations comprising:
receiving input data;
simulating variables based upon the input data;
predicting closures based upon the input data and the variables;
simulating outputs based upon the closures; and
updating a machine-learning (ML) model based upon the outputs to produce an updated ML model.

11. The computing system of claim 10, wherein the input data comprises superficial velocities of fluids, densities of the fluids, viscosities of the fluids, surface tensions for pairs of the fluids, a diameter of a pipe through which the fluids flow, an inclination of the pipe with respect to horizontal, a roughness of an interior of the pipe, or a combination thereof, and wherein the fluids comprise gas, oil, water, or a combination thereof.

12. The computing system of claim 11, wherein the operations further comprise transforming the input data to produce transformed input data, wherein the transformed input data comprises dimensionless Froude and Reynolds numbers that are based upon the superficial velocities of the fluids for the gas and an effective liquid with properties averaged between the oil and the water, a Weber number for a gas-effective liquid pair that is based upon the superficial velocity of the gas, a density ratio of the gas and the liquid, the inclination of the pipe, the roughness of the interior of the pipe, or a combination thereof.

13. The computing system of claim 11, wherein the variables are simulated using a simulator, wherein the simulator comprises a steady-state multiphase pipe flow simulator, wherein the variables comprise internal variables, and wherein the internal variables comprise in-situ velocities of the fluids, in-situ velocities of layers of the fluids, densities of the layers of the fluids, effective viscosities of the layers of the fluids, or a combination thereof.

14. The computing system of claim 13, wherein transforming the variables comprises transforming the internal variables, and wherein the transformed variables comprise dimensionless Froude and Reynolds numbers that are based on the in-situ velocities of the fluids, the in-situ velocities of the layers of the fluids, the densities of the layers of the fluids, the effective viscosities of the layers of the fluids, or a combination thereof.

15. The computing system of claim 10, wherein the closures comprise turbulence parameters, and wherein the ML model comprises a neural net.

16. A non-transitory computer-readable medium storing instructions that, when executed by one or more processors of a computing system, cause the computing system to perform operations, the operations comprising:
receiving input data;
simulating variables based upon the input data;
predicting closures based upon the input data and the variables;
simulating outputs based upon the closures; and
updating a machine-learning (ML) model based upon the outputs to produce an updated ML model.

17. The non-transitory computer-readable medium of claim 16, wherein the outputs are simulated using a simulator, and wherein the outputs comprise a pressure drop, a liquid holdup, a water holdup, an indicator of a flow regime, or a combination thereof.

18. The non-transitory computer-readable medium of claim 17, wherein the operations further comprise determining a loss function based upon the closures and/or the outputs, wherein the loss function comprises a quantitative measure of mismatch between the outputs and/or the closures compared versus experimental data, and wherein the loss function comprises a weighted sum of errors for the pressure drop, the liquid holdup, the water holdup, and/or the flow regime relative to the experimental data.

19. The non-transitory computer-readable medium of claim 18, wherein the operations further comprise determining gradients of the loss function, wherein the gradients are determined based upon derivatives of the loss function with respect to the outputs, derivatives of the outputs with respect to the closures, derivatives of the loss function with respect to the closures, and derivatives of the closures with respect to parameters of the ML model, and wherein the derivatives of the outputs are simulated using the simulator or by perturbing values of the closures and then approximating the perturbed values with finite difference formulas.

20. The non-transitory computer-readable medium of claim 16, wherein the ML model is updated by modifying parameters of the ML model, and wherein the parameters comprise matrices of weights and vectors of biases.
